(19) United States
(12) Patent Application Publication
(10) Pub. No.: US 2012/0050792 A1
(43) Pub. Date: Mar. 1, 2012

(54) Image forming apparatus, image forming method, and computer program

(75) Inventor: Takashi Uozumi, Kanagawa (JP)

(73) Assignee: Ricoh Company, Limited, Tokyo (JP)

(21) Appl. No.: 13/137,581

(22) Filed: Aug. 26, 2011

(30) Foreign Application Priority Data
Aug. 30, 2010 (JP) 2010-192862
Aug. 8, 2011 (JP) 2011-173183

(51) Int. Cl. G06K 15/02

(52) U.S. Cl. 358/1.15

(57) ABSTRACT

An image forming apparatus includes a print-job storing unit that stores therein a print job of a print target; a print control unit that switches between a normal print mode and a low-cost print mode; a print-time estimation unit that estimates a processing time to output all stored print jobs in the low-cost print mode; a time management unit that calculates a remaining time remaining within time period of a night-time electric power rate; and a determination unit that determines whether a time difference between the remaining time calculated by the time management unit and the processing time estimated by the print-time estimation unit is shorter than a predetermined time. When the time difference is determined to be shorter than the predetermined time, the print control unit outputs all print jobs in the low-cost print mode by the end time of the night-time electric power rate.

### CROSS-REFERENCE TO RELATED APPLICATIONS

The present application claims priority to and incorporates by reference the entire contents of Japanese Patent Application No. 2010-192862 filed in Japan on Aug. 30, 2010 and Japanese Patent Application No. 2011-173183 filed in Japan on Aug. 8, 2011.

### BACKGROUND OF THE INVENTION

1. Field of the Invention

The present invention relates to an image forming apparatus, image forming method, and a computer program that reduce the cost of electricity during printing.

2. Description of the Related Art

A conventional image forming apparatus generally uses, as an efficient and effective unit of a system for fixing toner images, a heat fixing device that has a heating roller with a built-in halogen heater that produces heat by using AC power. In a multifunction peripheral, when an image is printed onto a transfer sheet; the heat fixing device fixes toner to a transfer sheet at a high fixing temperature of, for example, 180 degrees in centigrade; however, a large amount of electricity is required to generate the heat energy for the high temperature, which results in a large cost of electricity. In order to reduce the cost of electricity that is mainly consumed by the heat fixing device, there is a technique, for example, in which the toner is fixed to a transfer sheet at a lower fixing temperature than the high temperature described above and spending enough time with a lower conveying speed for the transfer sheet to be conveyed. Furthermore, a technique is also known in which, in order to achieve the lowest cost of electricity, a time to execute a print job is set in a night time when a low electric power rate applies (for example, see Japanese Patent Application Laid-open No. 2008-103837).

In the technology disclosed in Japanese Patent Application Laid-open No. 2008-103837, as described above, there has been a problem in that, if a new print job is generated in the period of time in which the night-time electric power rate is about to end, the output of a job that needs to be printed cannot be completed during the period of time in which a low electric power rate applies.

### SUMMARY OF THE INVENTION

It is an object of the present invention to at least partially solve the problems in the conventional technology.

According to an aspect of the present invention, there is provided an image forming apparatus including: a print-job storing unit that stores therein a print job of a print target; a print control unit that switches, when outputting a print job stored in the print-job storing unit, a print mode between a normal print mode and a low-cost print mode, the low-cost print mode having a lower speed and lower power consumption than the normal print mode; a print-time estimation unit that estimates a processing time to output, in the low-cost print mode, all print jobs stored in the print-job storing unit; a time management unit that calculates a remaining time remaining within time period of a night-time electric power rate, the remaining time being a difference between end time of the time period and the current time; and a determination unit that determines whether a time difference between the remaining time calculated by the time management unit and the processing time estimated by the print-time estimation unit is shorter than a predetermined time. When it is determined, as a result of determination by the determination unit, that the time difference is shorter than the predetermined time, the print control unit outputs all print jobs stored in the print-job storing unit in the low-cost print mode within the time period of the night-time electric power rate and, conversely, when it is determined that the time difference is not shorter than the predetermined time, keeps all the print jobs stored in the print-job storing unit on standby.

According to another aspect of the present invention, there is provided an image forming method including: storing a print job of a print target; estimating a processing time to output all print jobs stored at the storing in a low-cost print mode that consumes low power; calculating a remaining time remaining within time period of a night-time electric power rate, the remaining time being a difference between end time of the time period and the current time; determining whether a time difference between the remaining time calculated at the calculating and the processing time estimated at the estimating is shorter than a predetermined time; and switching a print mode between a normal print mode and the low-cost print mode such that when it is determined, as a result of determination at the determining, that the time difference is shorter than the predetermined time, the print mode is switched from the normal print mode to the low-cost print mode so that all print jobs stored at the storing are output in the low-cost print mode within the time period of the night-time electric power rate, and, conversely, when it is determined that the time difference is not shorter than the predetermined time, the print job stored at the storing is kept on standby.

According to still another aspect of the present invention, there is provided a computer readable storage medium having computer-readable program codes embodied in the medium, the program codes when executed causing a computer to execute: storing a print job of a print target;

estimating a processing time to output all print jobs stored at the storing in a low-cost print mode that consumes low power; calculating a remaining time remaining within time period of a night-time electric power rate, the remaining time being a difference between end time of the time period and the current time; determining whether a time difference between the remaining time calculated at the calculating and the processing time estimated at the estimating is shorter than a predetermined time; and switching a print mode between a normal print mode and the low-cost print mode such that when it is determined, as a result of determination at the determining, that the time difference is shorter than the predetermined time, the print mode is switched from the normal print mode to the low-cost print mode so that all print jobs stored at the storing are output in the low-cost print mode within the time period of the night-time electric power rate, and, conversely, when it is determined that the time difference is not shorter than the predetermined time, the print job stored at the storing is kept on standby.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating the system configuration of an image forming apparatus according to the present embodiment;

FIG. 2 is a block diagram illustrating the functional configuration of a control unit that is executed by a central processing unit (CPU);

FIG. 3 is a flowchart illustrating a process performed when the night-time electric power rate applies according to the first embodiment;

FIG. 4 is an explanatory diagram illustrating the time periods in which a normal print mode and a low-cost print mode are switched;

FIG. 5 is a flowchart illustrating a detailed process performed at step S5 of FIG. 3;

FIG. 6 is a flowchart illustrating a process of print-mode switching according to a second embodiment;

FIG. 7 is an explanatory diagram illustrating a case where, when all stored print jobs are output immediately before the end time of the night-time electric power rate, the order of the print jobs is not changed; and

FIG. 8 is an explanatory diagram illustrating a case where, when all stored print jobs are output immediately before the end time of the night-time electric power rate, the order of the print jobs is changed.

### DETAILED DESCRIPTION OF THE PREFERRED EMBODIMENTS

Exemplary embodiments of the present invention are explained in detail below with reference to the accompanying drawings. According to the present invention, when a document is to be output in a low-cost print mode at a low temperature and a low speed in response to an instruction to print the document while in a stand-by mode in the night time, it is determined whether the print output will be completed by the end of a period of time in which the night-time electric power rate applies.

### First Embodiment

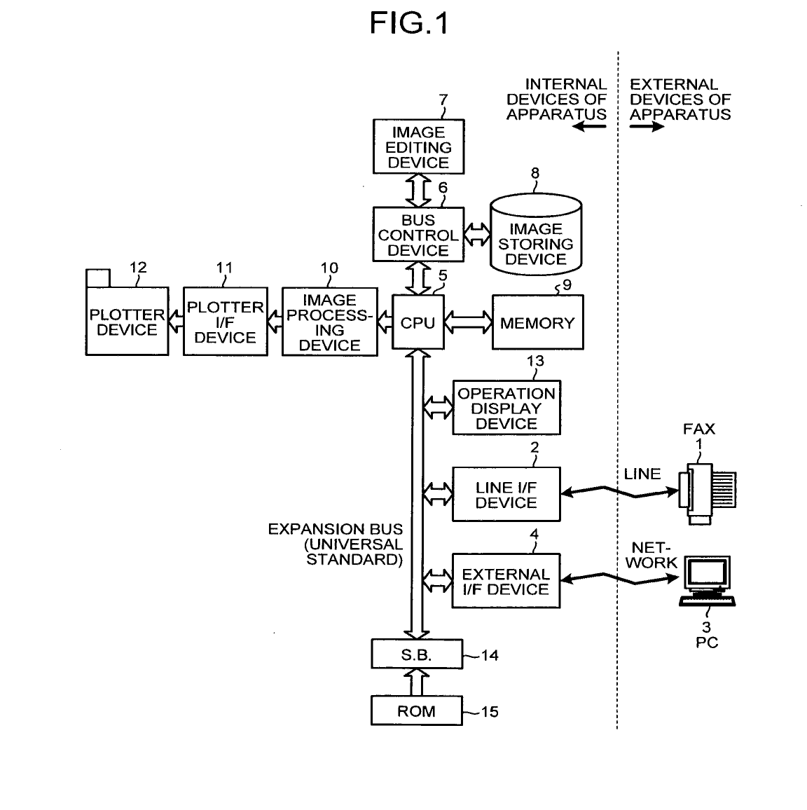

FIG. 1 is a block diagram illustrating the system configuration of an image forming apparatus (hereafter, referred to as a multi function printer (MFP)) according to the present embodiment. The MFP can transmit/receive image data to/from a facsimile apparatus (FAX) 1, which is externally connected to the MFP via a phone line and a line interface (I/F) device 2. Furthermore, the MFP can input/output various control commands and image data from/to a personal computer (PC) 3, which is externally connected to the MFP via a network and an external I/F device 4.

A CPU 5 is a microprocessor that controls the whole of the MFP. The CPU 5 performs management, for example, switches between the normal print mode and the low-cost print (low-speed print) mode, calculates the processing time of a print job, determines the order of print jobs, book a low electric-power period of time which is scheduled in the night time, obtains the current time, and the like.

A bus control device 6 communicates various types of data, such as image data or control commands that are necessary for the MFP. An image editing device 7 performs processing, such as density adjustment, sharpness/softness adjustment, page arrangement, or designated color conversion, on image data stored in an image storing device 8. The image storing device 8 is a storage device that stores digital image data and accompanying information on the digital image data. A memory 9 is a volatile memory that is used for, for example, temporarily storing computer programs or intermediate process data when the CPU 5 controls the MFP.

An image processing device 10 is a device that converts digital image data transmitted from the CPU 5 into image suitable for a plotter device 12. A plotter I/F device 11 receives CMYK (cyan, magenta, yellow, and black) digital image data from the image processing device 10 and outputs the digital image data to a dedicated I/F of the plotter device 12.

When receiving CMYK digital image data, the plotter device 12 forms images on a transfer sheet by using units that are arranged and configured according to optical writing using laser beams and an electrophotographic process, a sheet conveying unit, a fixing unit, and the like. An operation display device 13 is a unit that functions as an interface between the MFP and a user. The operation display device 13 includes a liquid crystal display device (LCD), key switches, and the like. The operation display device 13 displays, on the LCD, various conditions of the MFP and operation procedures and detects a user input using the key switches. A south bridge (S.B.) 14 is a general-purpose circuit that has a bridge function for buses. A ROM 15 is a memory that stores computer programs used when the CPU 5 controls the MFP.

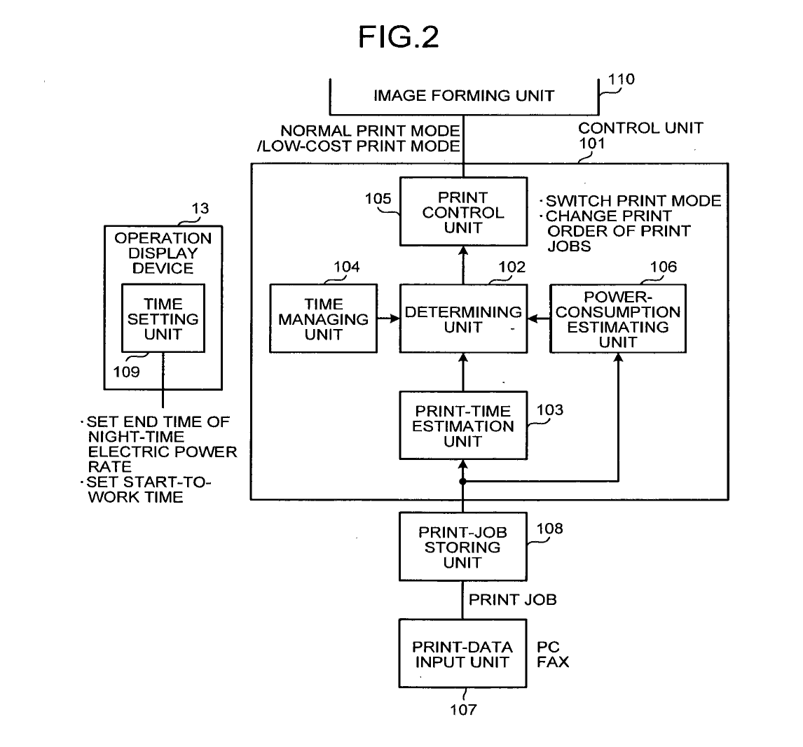

FIG. 2 is a block diagram illustrating the functional configuration of a control unit that is executed by the CPU 5. A control unit 101 includes a determination unit 102; a print-time estimation unit 103 that estimates the time required to complete printing of a print job (document); a time management unit 104 that manages the current time, the time at which the electric power rate is changed, and the like; a print control unit 105 that switches between the normal print mode and the low-cost (low-power consumption) print mode; and a power-consumption estimation unit 106 that estimates the power consumption necessary for printing of each stored document.

The print control unit 105 switches between the above-described print modes and changes the order of print jobs to be processed. A print-data input unit 107 receives a print job of a print target from, for example, the FAX 1 or the PC 3. A print-job storing unit 108 is provided by the image storing device 8 and stores, by using a memory function, a print job that is input through the print-data input unit 107. A time setting unit 109 is provided on the operation display device 13. The time setting unit 109 has a setting function for setting the end time of the night-time electric power rate, setting the work start/end time of a user, or the like. An image forming unit 110 is provided by the plotter device 12. The image forming unit 110 includes a heat fixing device that has a heating roller with a built-in halogen heater that produces heat by using alternating current (AC) power. The image forming unit 110 outputs an image of a print job that is formed by using an electrophotographic system.

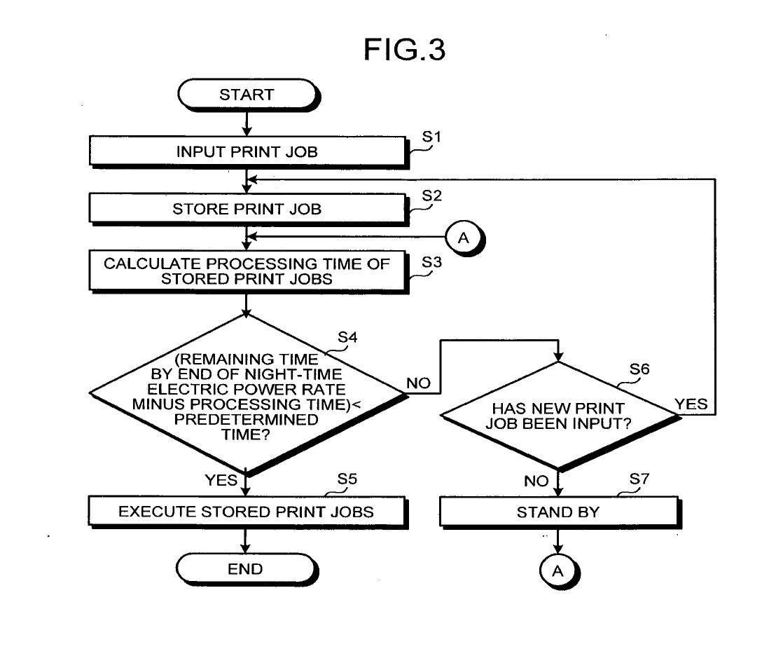

FIG. 3 is a flowchart illustrating a process sequence performed when the night-time electric power rate applies according to the first embodiment. The process sequence is performed by the control unit 101.

As illustrated in FIG. 3, when a print job (print document) is input from an external device, such as the FAX 1 or the PC 3, via the print-data input unit 107 (step S1), the input print job is stored in the image storing device 8 (the print-job storing unit 108) (step S2). Next, based on the amount of image data for the print job, the print-time estimation unit 103 calculates the processing time needed to print, in the low-cost print mode, the print job stored at step S2 and an already stored print job (step S3).

The time management unit 104 acquires the current time from an internal clock in the MFP and acquires the end time for the period of the night-time electric power rate that is set at, for example, the operation display device 13. The time management unit 104 then calculates the remaining time to be elapsed till the end of the period in which the night-time electric power rate applies, i.e., the time difference between the end time of the night-time electric power rate and the current time. The determination unit 102 compares the processing time of the print jobs calculated by the print-time estimation unit 103 with the remaining time to be elapsed until the end time of the period for the night-time electric power rate so as to determine whether or not there remains sufficient time to complete print jobs by the end time of the period for the electric power rate (step S4).

As a result of the determination obtained by the determination unit 102, if the remaining time to be elapsed until the end time for the period of the night-time electric power rate is insufficient, i.e., if the time difference as calculated above is shorter than a pre-set period of time (Yes at step S4), the print control unit 105 outputs the stored print jobs in the low-cost print (low-power consumption) mode (step S5). Thus, a print job is output during a period of time in which the night-time electric power rate applies, so that the print job is performed with a reduced cost (electricity consumption).

Conversely, if it is determined by the determination unit 102 that there is sufficient time remaining to be elapsed until the end time for the period of the night-time electric power rate, i.e., if the time difference as calculated above is longer than the pre-set period of time (No at step S4), the print job is stored by keeping on standby. The determination unit 102 then determines whether or not a subsequent print job has been input (step S6). If a new print job has been input (Yes at step S6), the print job is once stored in the image storing device 8 (step S2), the processing time to print the newly stored print job and the already stored print job in the low-cost print mode is calculated (step S3), and it is determined again by the determination unit 102 whether or not printing is to be performed (step S6).

If a new print job has not been input (No at step S6), the control unit 101 once stays on stand-by (step S7). After the elapse of a certain period of time, the print-time estimation unit 103 calculates the processing time to print all the stored print jobs in the low-cost print mode (step S3), and the determination unit 102 determines again whether or not printing is to be performed (step S6).

By checking the print starting condition on a regular basis according to the above-described processes, a print job is executed in the low-cost print (low-power consumption) mode during a period of time when a night-time electric power rate applies with a low cost of electricity and, because the heating roller is heated at once, the cost of electricity can be reduced.

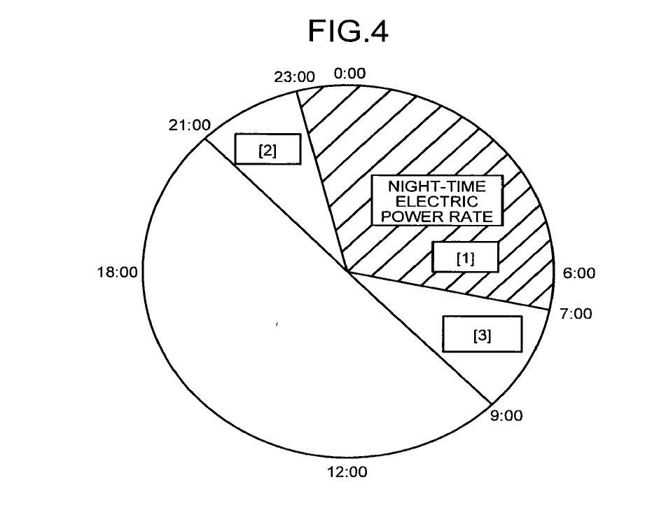

FIG. 4 is an explanatory diagram illustrating the periods of time in which the normal print mode and the low-cost print mode are switched. In FIG. 4, the periods of time are represented on a 24-hour basis. The period of time indicated by [1] in FIG. 4 is a period of time from 23:00 hrs to 07:00 hrs within which the night-time electric power rate applies and is a period of time when the cost of electricity is lower than that in a period of time in the day time. The period of time indicated by [2] in FIG. 4 is a period of time from 21:00 hrs, during which the number of users in an office decreases and the MFP often enters a stand-by mode, to 23:00 hrs when the night-time electric power rate begins. A user can set the length of this period of time by using the time setting unit 109 provided on the operation display device 13.

The period of time indicated by [3] in FIG. 4 is a period of time from 07:00 hrs, at which time the low night-time electric power rate ends, to 09:00 hrs, at which time users start to work in the office, and is a period of time in which the MFP often enters the stand-by mode. A user can set the beginning of the business hours by using the time setting unit 109 provided on the operation display device 13.

The flowchart of the processes performed when the night-time electric power rate applies, as illustrated in FIG. 3, applies to the period of time indicated by [1]. Even if a job print command is received from the FAX 1, or the like, the job is not immediately performed. First, the processing time for warming-up and outputting in the low-cost print mode is calculated. If it is determined that an operation will be finished by 07:00 hrs, the print job is stored and the stand-by mode is maintained. This is to reduce the cost of electricity for warming-up. If print jobs are accumulated and if the processing time becomes close to the period of the remaining time remaining to be elapsed until 07:00 hrs, warming-up is performed for the first time and the print jobs are output by taking time in the low-cost print mode.

If a print command for a print job is issued during the period of time indicated by [2] and if the MFP is in a stand-by mode, the print job is not instantly output. The print job is stored instead, and the stand-by mode is maintained until the beginning of the time indicated by [1]. Thus, the number of warming-ups can be decreased, and, because a print job is output during a period of time when the low electric power rate is applied, the cost can be significantly reduced.

If a print command for a print job is issued during the period of time indicated by [3] while the MFP is in a stand-by mode, the print job is not instantly output, and the print job is stored by keeping on standby instead. When a user uses the MFP at 09:00 hrs, warming-up is conducted and the print jobs are all output. Thus, the number of unnecessary warming-ups can be decreased and the cost of electricity can be reduced.

In both the periods of time indicated by [2] and [3], when the MFP is in a stand-by mode, it is likely that there are fewer number of users around the MFP than in a day time or there may be no users. Therefore, a stored print job does not have to be instantly output; thus, the print job can be output with all other print jobs and, as a result, the cost of electricity required for a print process can be reduced.

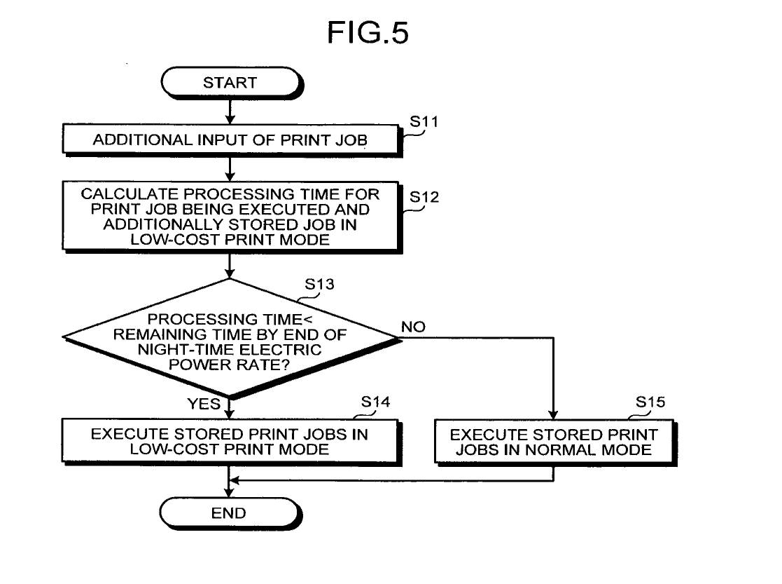

FIG. 5 is a flowchart illustrating the details of the process sequence at step S5 of FIG. 3. The process sequence illustrates a case in which a print job is executed when the night-time electric power rate applies.

As illustrated in FIG. 5, when all stored print jobs are printed in the low-cost print mode before the night-time electric power rate period ends, a different print job may be additionally input (step S11). Then, the print-time estimation unit 103 calculates the processing time needed to continuously output the print job being currently executed and the additionally stored print job in the low-cost print mode (step S12).

The determination unit 102 then determines whether or not the estimated processing time of the print jobs is shorter than the remaining time to be elapsed until the end of the night-time electric power rate (the time difference between the end time of the night-time electric power rate and the current time) (step S13). If it is determined by the determination unit 102 that the print jobs can be completed within the time period of the night-time electric power rate by a continuous execution of printing in the low-cost print mode (Yes at step S13), the print control unit 105 executes all the stored print jobs in the low-cost print mode (step S14). Conversely, if it is determined by the determination unit 102 that the printing process cannot be completed within the time period of the night-time electric power rate if the low-cost print mode is continuously executed (No at step S13), the normal print mode with a higher processing speed is executed so as to complete the process while the night-time electric power rate applies (step S15).

By the above-described processes, even when a print job is added when print jobs, which are stored in the night time, are all output in the low-cost print mode, the print process can be completed during when the night-time electric power rate applies for low cost of electricity.

Thus, according to the above-described embodiment, a print process is completed in the night time when a low electric power rate applies by switching between the low-cost print mode and the normal print mode, so that the cost of electricity can be reduced.

### Second Embodiment

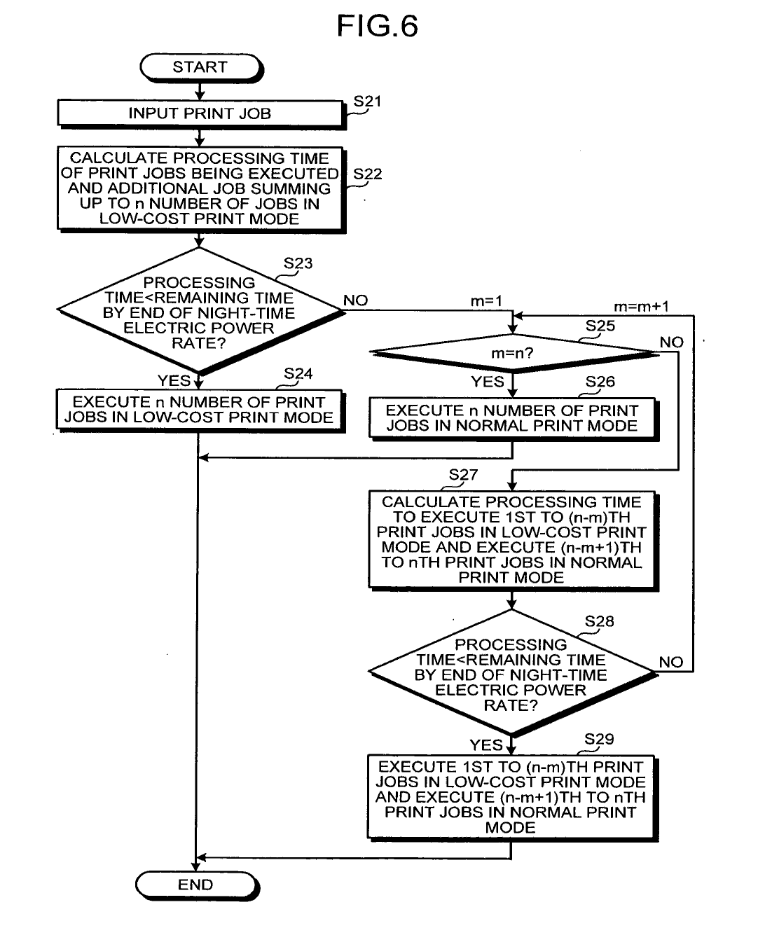

FIG. 6 is a flowchart illustrating a process of print-mode switching according to a second embodiment. In the process sequence illustrated in FIG. 5, print-mode switching is performed by comparing the processing time of the jobs in the low-cost print mode with the remaining time to be elapsed until the end time of the night-time electric power rate when a print job is added during printing in the low-cost print mode. Then, based on the comparison result, the determination unit 102 determines whether or not the process is to be switched between a low-cost print mode and a normal print mode. Thus, according to the second embodiment, the determination process is executed when the additional print job is added to the print job that is being executed (FIG. 5 (step S13)).

According to the present embodiment, an explanation is given of a switching method by which the process is performed in the low-cost print mode until immediately before the end time of the night-time electric power rate on the assumption that the print jobs are to be completed by the end time so that the cost of electricity is reduced.

When all the stored print jobs are printed in the low-cost print mode before the night-time electric power rate period ends, a different print job may be additionally input (step S21). At that time, the print-time estimation unit 103 calculates the processing time needed to continuously output, in the low-cost print mode, all n number of print jobs obtained by the summation of the print jobs being currently executed and an additionally stored print job (step S22). The determination unit 102 then determines whether or not the calculated processing time of the print jobs is shorter than the remaining time remaining to be elapsed until the end time of the night-time electric power rate (the time difference between the end time of the night-time electric power rate and the current time) (step S23).

As a result of the determination, if the print jobs can be completed within the time period of the night-time electric power rate even when the low-cost print mode is continuously executed (Yes at step S23), the print control unit 105 executes all n number of the stored print jobs in the low-cost print mode (step S24).

As a result of the determination, if it is determined printing in the low-cost print mode cannot be completed within the time period of the night-time electric power rate (No at step S23), the print control unit 105 executes stored print jobs, starting with the m-th print job from the end of a queue of the stored print jobs, in the normal print mode so that the print process can be completed within the time period of the night-time electric power rate. In the process, m is incremented from 1 in the numeric order so that the process is performed in the low-cost print mode as much as possible.

First, the determination unit 102 checks whether m=n (step S25). If m=n (Yes at step S25), the print control unit 105 executes all n number of print jobs in the normal print mode (step S26). If m≠n (No at step S25), the print-time estimation unit 103 calculates the processing time needed to execute the 1st to (n−m)-th print jobs in the low-cost print mode and to execute the (n−m+1)-th to n-th print jobs in the normal print mode (step S27). The determination unit 102 then determines whether or not the calculated processing time of the print jobs is shorter than the remaining time to be elapsed until the end time of the night-time electric power rate (the time difference between the end time of the night-time electric power rate and the current time) (step S28).

If the above-described processing time is shorter than the remaining time remaining to be elapsed until the end time of the night-time electric power rate (Yes at step S28), the print control unit 105 executes the 1st to the (n−m)-th print jobs in the low-cost print mode and executes the (n−m+1)-th to n-th print jobs in the normal mode (step S29). If the above-described processing time is longer than the remaining time remaining to be elapsed until the end time of the night-time electric power rate (No at step S28), the print-time estimation unit 103 increments the above number m by 1 so as to increase the number of print jobs to be output in the normal print mode by 1 and then calculates the processing time again.

By performing the above process, as many of the print jobs as possible can be performed in the low-cost print mode so that the cost of electricity can be reduced.

Thus, according to the above-described embodiment, as many of the print jobs as possible are output in the low-cost print mode by the end of a period of time when a low electric power rate applies and the remaining print jobs are output in the normal print mode so that the process is completed during the period of time when a low electric power rate applies, and the low-cost print mode is used as much as possible so that the cost of electricity can be reduced.

### Third Embodiment

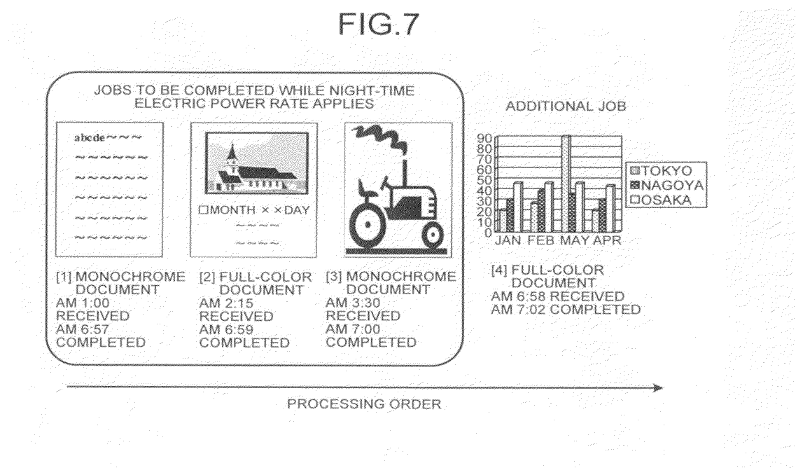

FIG. 7 is an explanatory diagram illustrating a case where, when all stored print jobs are output immediately before the end time of the night-time electric power rate, the order of the print jobs is not changed.

As illustrated in FIG. 7, the monochrome document [1] is received at 1:00 a.m., the full-color document [2] is received at 2:15 a.m., and the monochrome document [3] is received at 3:30 a.m. If the processing time of each of the received monochrome documents, calculated by the print-time estimation unit 103, is one minute and the processing time of the received color document, calculated by the print-time estimation unit 103, is two minutes, the heating roller is heated immediately before 6:56 a.m., the print jobs are processed in the order they have been stored, i.e., [1], [2], and then [3], and the print jobs are completed by 7:00 a.m. when the period of time in which the night-time electric power rate applies ends.

Suppose that a print job for the full-color document [4], for which the processing time, calculated by the print-time estimation unit 103, is two minutes, is added at 6:58 a.m. If the order of the print jobs is not changed, the added print job is to be the final print job to be output. Then, the process for the full-color document [4] starts at 7:00 a.m. when the time period for the night-time electric power rate ends, and the process is completed at 7:02 a.m.

### Fourth Embodiment

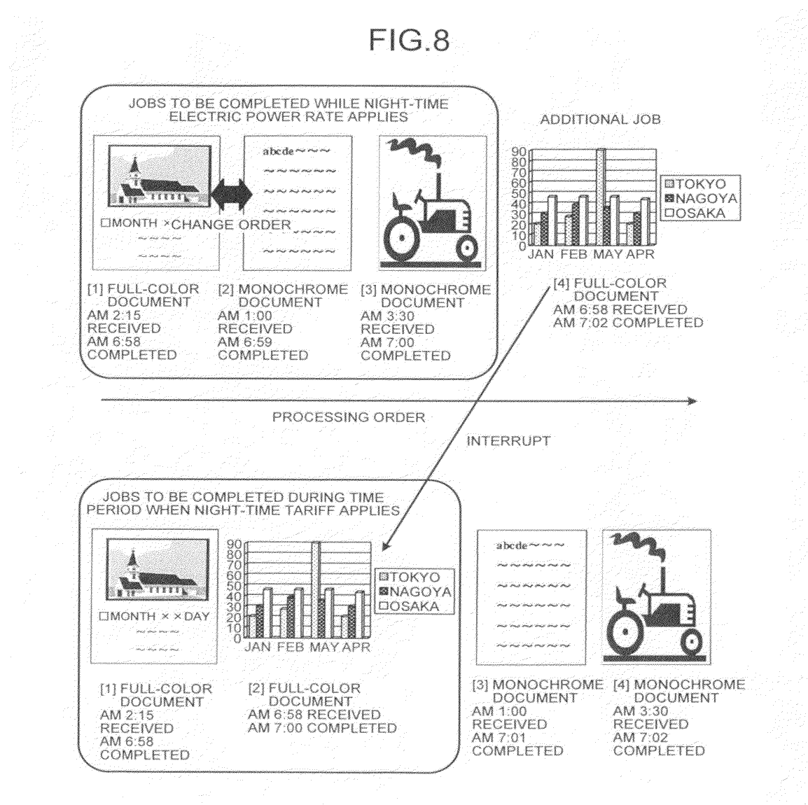

FIG. 8 is an explanatory diagram illustrating a case where, when stored print jobs are all output immediately before the end time of the night-time electric power rate, the order of the print jobs is changed.

The cost for printing a full-color document is higher than that of a monochrome document. This is because, in addition to a larger variety of toner to be used, the amount of toner to be used is greater and the amount of heat (heating time) of the heating roller becomes larger, resulting in an increase in the electricity consumption.

Therefore, even if a print job remains unprocessed when the period of time for the night-time electric power rate ends, the process of full-color printing, for which a large amount of electricity is required, is given priority while the night-time electric power rate applies and monochrome printing is performed while the normal electric power rate applies; thus, a printing cost can be effectively reduced even if there is a large number of additional print jobs.

According to the present embodiment, if print jobs are processed all together immediately before the end of the night-time electric power rate, the power-consumption estimation unit 106 detects a full-color document based on the amount of power consumption of the print job, and the determination unit 102 changes the order of the print jobs in accordance with the detection result so that the process of the full-color document is given priority.

FIG. 8 illustrates an example where the monochrome document [2] is received at 1:00 a.m., the full-color document [1] is received at 2:15 a.m., and the monochrome document [3] is received at 3:30 a.m. The processing time of each of the received monochrome documents, calculated by the print-time estimation unit 103, is one minute, and the processing time of the received full-color document, calculated by the print-time estimation unit 103, is two minutes. Because the output of the full-color document [1] is given priority, the heating roller is heated immediately before 6:56 a.m., the print jobs are processed from 6:56 a.m. in a different order from the order they have been stored, i.e., in the order [1], [2], and [3], and the print jobs are completed at 7:00 a.m. when the night-time electric power rate ends.

Then, a print job of the full-color document [4], for which the processing time, calculated by the print-time estimation unit 103, is two minutes, is added at 6:58 a.m. According to the present embodiment, because the full-color document [4] is given priority for printing, the full-color document [4] is processed before the unprocessed monochrome documents. In this case, the process for printing the full-color document [4] is started at 6:58 a.m. when the night-time electric power rate applies, and the process is completed at 7:00 a.m. The two print jobs for printing the monochrome documents still remain; however, because the power consumption is low for the monochrome printing, the cost is low even when the normal electric power rate applies to the execution of the print jobs for the monochrome documents.

Thus, the order of print jobs is changed so that, even if a process is not completed during the period of time when the night-time electric power rate applies, the cost of electricity can be reduced.

Thus, according to the above-described embodiment, priority is given to the processes for the stored print jobs for which the power consumption is large, and high power-consumption processes are completed, in the night time, in the time period in which a low electric power rate applies so that the cost of electricity can be reduced.

A computer program to be executed according to the present embodiment is provided such that it is installed in, but not limited to, the memory 9 or the ROM 15 in advance. A computer program to be executed according to the present embodiment may be provided, as a computer program product, by being stored, in the form of a file that is installable or executable, in a recording medium readable by a computer, such as a compact disk read-only memory (CD-ROM), a flexible disk (FD), a CD recordable (CD-R), or a digital versatile disk (DVD).

Furthermore, a configuration may be such that a computer program to be executed according to the present embodiment is stored in a computer connected to a network such as the Internet and provided by being downloaded via the network. Moreover, a configuration may be such that a computer program to be executed according to the present embodiment is provided or distributed via a network such as the Internet.

A computer program to be executed according to the present embodiment has a modular configuration that includes the control unit 101 including the above-described units (the determination unit 102, the print-time estimation unit 103, the time management unit 104, the print control unit 105, and the power-consumption estimation unit 106). In terms of actual hardware, the CPU 5 (processor) reads a computer program from the above-described recording medium and executes the read computer program so as to load the above-described units into main storage, such as the memory 9, so that each of the determination unit 102, the print-time estimation unit 103, the time management unit 104, the print control unit 105, and the power-consumption estimation unit 106 is generated in the main storage.

According to an aspect of the present invention, normal printing and low-temperature low-speed printing (toners are fixed with a low temperature and at a low speed so that the heating temperature of a fixing roller can be decreased) are switched depending on the number of jobs and the remaining time remaining to be elapsed until the end of a night-time electric power rate, and priority is given to outputs of full-color printing jobs, or the like, for which the cost of electricity is high, when the night-time electric power rate applies; thus, it is possible to reduce the cost for printing, to reduce the risk of having a job not completed during the night time when a low electric power rate applies, and to output a job at a low cost even when the job is not completed during the night time when a low electric power rate applies.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a print-job storing unit that stores therein a print job of a print target;
a print control unit that switches, when outputting a print job stored in the print-job storing unit, a print mode between a normal print mode and a low-cost print mode, the low-cost print mode having a lower speed and lower power consumption than the normal print mode;
a print-time estimation unit that estimates a processing time to output, in the low-cost print mode, all print jobs stored in the print-job storing unit;
a time management unit that calculates a remaining time remaining within time period of a night-time electric power rate, the remaining time being a difference between end time of the time period and the current time; and
a determination unit that determines whether a time difference between the remaining time calculated by the time management unit and the processing time estimated by the print-time estimation unit is shorter than a predetermined time, wherein
when it is determined, as a result of determination by the determination unit, that the time difference is shorter than the predetermined time, the print control unit outputs all print jobs stored in the print-job storing unit in the low-cost print mode within the time period of the night-time electric power rate and, conversely, when it is determined that the time difference is not shorter than the predetermined time, keeps all the print jobs stored in the print-job storing unit on standby.

2. The image forming apparatus according to claim 1, wherein
if a new print job is additionally input when the print job stored in the print-job storing unit is being output in the low-cost print mode before end of the time period of the night-time electric power rate, the print-time estimation unit estimates a processing time to output, in the low-cost print mode, the print job stored in the print-job storing unit and currently being executed and the new print job,
the determination unit determines whether the processing time estimated by the print-time estimation unit exceeds the remaining time, and
the print control unit is configured to
when it is determined that the processing time does not exceed the remaining time, output, in the low-cost print mode, the print job stored in the print-job storing unit and currently being executed and the new print job, and
conversely, when it is determined that the processing time exceeds the remaining time, switch to the normal print mode so that output of the print job stored in the print-job storing unit and currently being executed and the new print job is completed within the time period of the night-time electric power rate.

3. The image forming apparatus according to claim 2, wherein, when it is determined, as a result of the determination by the determination unit, that the processing time exceeds the remaining time and, when a processing time to output a part of the stored print job currently being executed and the new print job in the low-cost print mode and to output a remaining print job in the normal print mode does not exceed the remaining time, the print control unit outputs the part of the print job in the low-cost print mode and switches to the normal print mode to output the remaining print job.

4. The image forming apparatus according to claim 1, wherein the print control unit changes an order of the stored print jobs when the print jobs are output.

5. The image forming apparatus according to claim 4, further comprising a power-consumption estimation unit that estimates an amount of power consumption necessary for executing the print job, wherein
the print control unit changes the order of the print jobs depending on the amount of power consumption estimated by the power-consumption estimation unit.

6. The image forming apparatus according to claim 5, wherein the print control unit changes the order of the print jobs such that a print process is performed with priority given to color printing for which an amount of power consumption is large.

7. An image forming method comprising:
storing a print job of a print target;
estimating a processing time to output all print jobs stored at the storing in a low-cost print mode that consumes low power;
calculating a remaining time remaining within time period of a night-time electric power rate, the remaining time being a difference between end time of the time period and the current time;
determining whether a time difference between the remaining time calculated at the calculating and the processing time estimated at the estimating is shorter than a predetermined time; and
switching a print mode between a normal print mode and the low-cost print mode such that
when it is determined, as a result of determination at the determining, that the time difference is shorter than the predetermined time, the print mode is switched from the normal print mode to the low-cost print mode so that all print jobs stored at the storing are output in the low-cost print mode within the time period of the night-time electric power rate, and, conversely, when it is determined that the time difference is not shorter than the predetermined time, the print job stored at the storing is kept on standby.

8. A computer readable storage medium having computer-readable program codes embodied in the medium, the program codes when executed causing a computer to execute:
storing a print job of a print target;
estimating a processing time to output all print jobs stored at the storing in a low-cost print mode that consumes low power;
calculating a remaining time remaining within time period of a night-time electric power rate, the remaining time being a difference between end time of the time period and the current time;
determining whether a time difference between the remaining time calculated at the calculating and the processing time estimated at the estimating is shorter than a predetermined time; and
switching a print mode between a normal print mode and the low-cost print mode such that
when it is determined, as a result of determination at the determining, that the time difference is shorter than the predetermined time, the print mode is switched from the normal print mode to the low-cost print mode so that all print jobs stored at the storing are output in the low-cost print mode within the time period of the night-time electric power rate, and, conversely, when it is determined that the time difference is not shorter than the predetermined time, the print job stored at the storing is kept on standby.
